(19) United States
(12) Patent Application Publication
(10) Pub. No.: US 2003/0177160 A1
(43) Pub. Date: Sep. 18, 2003

(54) Predictive system for self-managed e-business infrastructures

(75) Inventors: Willy Wai-Yee Chiu, Los Altos, CA (US); Yin Chen, Sunnyvale, CA (US); Lawrence Shun-mok Hsiung, Los Altos, CA (US); Noshir Cavas Wadia, Morgan Hill, CA (US); Peng Ye, Fremont, CA (US)

Correspondence Address: INTERNATIONAL BUSINESS MACHINES CORP, IP LAW, 555 BAILEY AVENUE , J46/G4, SAN JOSE, CA, 95141, US

(73) Assignee: Internationl Business Machines Corporation, Armonk, NY

(21) Appl. No.: 10/100,575

(22) Filed: Mar. 14, 2002

(51) Int. Cl. G06F 9/00

(52) U.S. Cl. 709/100

(57) ABSTRACT

The invention relates to scheduling multiple tasks running on multiple platforms by analysis and consideration of various factors and metrics, e.g., priority of execution, balancing the work load, balancing of resources, resource availability, time constraints, etc. through such expedients as task assignment, (i.e., deciding which processor or other resources will be used to execute one or more tasks). The purpose is to minimize processing execution time and client waiting time by efficiently distributing workload among operational computers, processors and other system resources. The relationship of real world server workload versus time, measured against various metrics and historical data, with an intermediate result used to simulate future demand. This simulation of future demand is then used to reconfigure the system to meet the demand, thereby providing higher degrees of self management and autonomy to the web site.

### FIELD OF THE INVENTION

The invention relates to scheduling multiple tasks running on multiple server platforms by analysis and consideration of various factors and metrics, e.g., priority of execution, balancing of work load, balancing of resources, resource availability, time constraints, etc. through such expedients as task assignment, (i.e., deciding which processor or other resources will be used to execute one or more tasks). The purpose is to minimize processing execution time and client waiting time by efficiently distributing workload among operational computers, processors and other system resources.

### BACKGROUND OF THE INVENTION

A dilemma faced by most high volume eBusiness websites, including web servers, application servers, and database servers, is that it's always difficult, however highly desirable, to find a cost-efficient way to meet some key performance metrics or services levels (especially those relating to availability) under unanticipated very high workload without investing heavily on the additional hardware resources that is idling most of the time.

During the last few years, e-commerce businesses have grown from “start-ups” to well established multi-million dollar enterprises. However, the transition has not been smooth, and users have encountered delays or even been entirely unable to access the business's Web servers.

Such problems often stem from poor, obsolete, or overly cautious capacity planning and the lack of robust performance monitoring tools. The products for monitoring system and network usage, which firms need to insure that systems and services are readily available, have been a step or two behind alluring store fronts and e-commerce web sites.

Keeping ahead of dramatic usage bursts is difficult in real time because response time problems can stem from a number of components. These include an ill-configured database management system, an overloaded application server, a slow Web server, an over-utilized data center LAN, a maladjusted load balancing switch, or an overworked Internet service provider connection.

Software products designed to monitor, diagnose, and help corporations manage enterprise networks and systems have recently been honed to examine Web system performance (again, including e-commerce availability). The goal remains to solve e-commerce Web availability problems.

Suggested solutions include autonomous tools to monitor system and network usage, tools and services to gauge availability (such as automated software agents that contact sites to determine whether preselected pages are available, calculate how long they take to load, and collect this information for analysis) including a range of availability metrics (time needed to identify a server's location, connection setup, first byte received, redirect delays, base-page download and content download, among others).

Site managers can use these systems in two ways. The first is immediate troubleshooting where e-mails or pager notifications tell network technicians that system performance is not meeting preset thresholds. The second is capacity planning. By collecting the performance data, information systems managers can deduce usage trends and decide to upgrade server hardware, divide applications among a couple of DBMS, change backbone configurations or move content closer to repeat users. However, while these expedients address planning problems, they do not address real-time availability issues.

Availability is a challenge. E-commerce merchants realize that they can't sustain viable e-commerce businesses if their sites are plagued by availability problems: major outages, slow performance, content errors and broken transactions. In the world of e-commerce, competitors' sites are just a click away. Business pressure is driving identification and remediation of availability problems, and motivating an approach to ever greater self-managing, autonomous sites.

### SUMMARY OF THE INVENTION

According to our invention, we provide a proactive solution that can project upcoming workload and dynamically simulate the system through a real-time heuristic analysis of both historic and real-time system loads and demands, then automatically allocate or reclaim resources ahead of time by using workload monitoring/prediction based on the heuristic analysis and high volume web site simulating techniques. This provides a degree of autonomy and self management. The method, system, and program product of our invention, in essence, transforms the eBusiness infrastructure into a virtually a self managed infrastructure. Consequently resources can be better utilized, and costs for both equipment and operations can be saved dramatically. This solution also improves the quality of service as seen by the web site visitors, as exemplified by availability and availability metrics.

By a “heuristic analysis” is meant a purposeful, partially informed (based on real time and historic data rather then blind guesses) procedure to seek a local or feasible solution to a global optimization problem, as in combinatorial optimization.

This is accomplished through a method, system, and program product for configuring a “queuing server” (As used herein, a “queuing server” is a generalized artifact of the type generally referred to as a server in classical systems analysis-operations research, such as a barber, a bank teller, or a web server, an e-commerce server, an application server, or a data base server) in a queue-queuing server environment. The first step is recovering operational data, preferably real time operational data, from the queuing server; and retrieving activity forecasts, typically based on historical data, from a related or associated database. Next, the forecasts and operational data are processed to obtain recommended queuing server configurations. This may be done using queuing equations or various modeling techniques. The recommended queuing server configurations are then processed to obtain queuing server response time predictions and server utilization predictions, which are used as the basis for reconfiguring the queuing server in response thereto. In a preferred exemplification the “queuing server” is a server used in e-commerce, as a web server, an application server, a data server, or a combination thereof.

The program product may reside on one computer or on several computers (as a client-server relationship, or a peer to peer relationship) or on a distribution server or a disk or disks or tapes. The program itself may be encrypted and/or compressed, as would be the case of distribution media or a distribution server, for example, before installation.

### THE FIGURES

The FIGURES attached hereto illustrate various aspects of our invention.

FIG. 1 illustrates the connection of an e-commerce web site server to clients (customers) through the World Wide Web. Shown are three clients, a generalized representation of the World Wide Web, a web server, and three sets of an application server, a data server, and a data base.

FIG. 2 illustrates the relationship of real world server workload versus time, measured against various metrics and historical data, with an intermediate result used to simulate future demand. This simulation of future demand is then used to reconfigure the system to meet the demand.

FIG. 3 is one representation of a flow chart for carrying out the method of the invention, on a system of the invention, using a program product of the invention.

### DETAILED DESCRIPTION OF THE INVENTION

As shown in the Figures, our system ties real time workload (basically the arrival rate of user visits to a web site) monitoring and prediction into a feedback system which includes a High Volume Web Site (“HVWS”) Simulator that can use the predicted upsurge/decline of workload arrivals, and historical data, as input to estimate end to end capacity required to meet a certain target response time, a key quality of service metric, and then feed the estimated required capacity into a control system that can increase or decrease system capacity ahead of time to either prevent performance degradation/server crash or save resources. In the mean time, the HVWS model will be updated to reflect the new system configuration. The whole process can operate in automatic or semi-automatic fashion.

Increasing or decreasing system capacity may be as simple as increasing or decreasing virtual or logical capacity (as by making more socket server capacity available or allowing storage in alternative database tables within a DBMS), or increasing physical capacity (as by routing access requests to a different physical web server or transactions to a different application server) or as complex as bringing additional platforms on line.

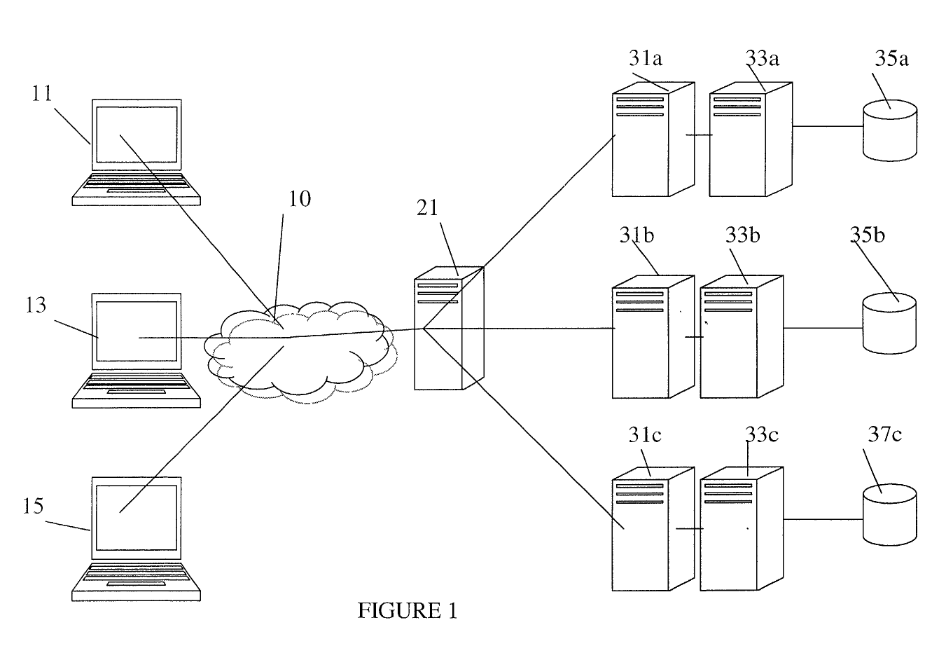

FIG. 1 illustrates the connection of an e-commerce web site server to clients (customers) through the World Wide Web. Shown are three Web clients, 11, 13, 15, a generalized representation of the World Wide Web, 10, a web server, 21, and three sets of an application server, 31a, 31b, and 31c, a data server, 33a, 33b, 33c, and a data base, 35a, 35b, and 35c.

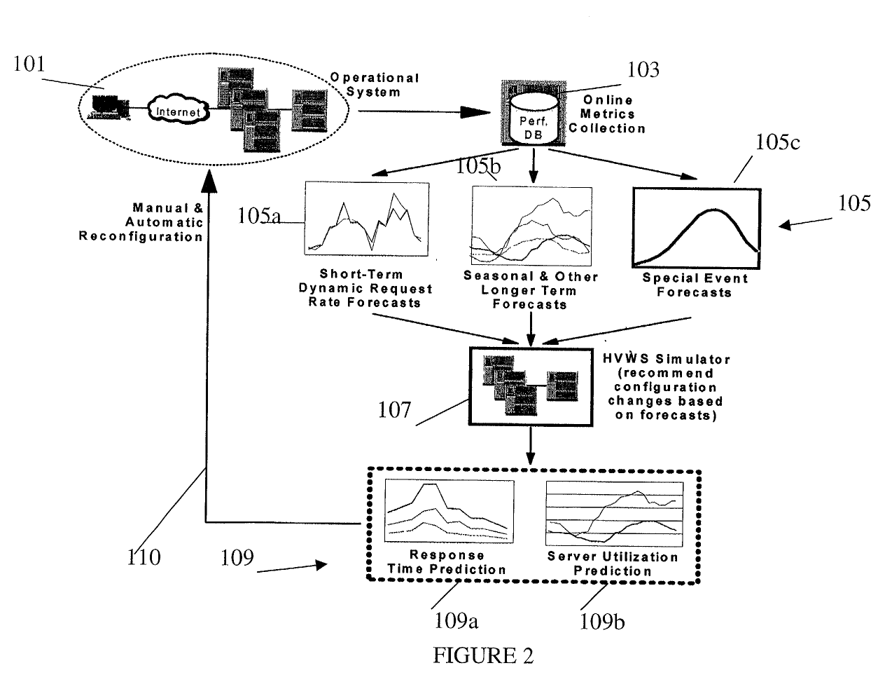

FIG. 2 illustrates the relationship of real world server workload versus time, measured against various metrics and historical data, with an intermediate result used to simulate future demand, especially near-term, real time, future, demand. This simulation of future demand is then used to reconfigure the system to meet the demand.

FIG. 2 shows an operational e-commerce system as part of the Web, 101. The method, system, and program product of the invention collects operational measures from the real time system, 101, for storage in and comparison with online metrics in a performance database, 103. These metrics are combined with other data, such as, short time dynamic request rate forecasts, 105a, seasonal and other longer term forecasts, 105b, and special event forecasts, 105c. These data and forecasts are input to a High Volume Web Site Simulator, 107, which recommends configurations and configuration changes, 109, based on forecasts, including a response time prediction 109a, and a server utilization prediction. These predictions are then used as control inputs, 110, to the servers, 101, for manual and automatic control actions.

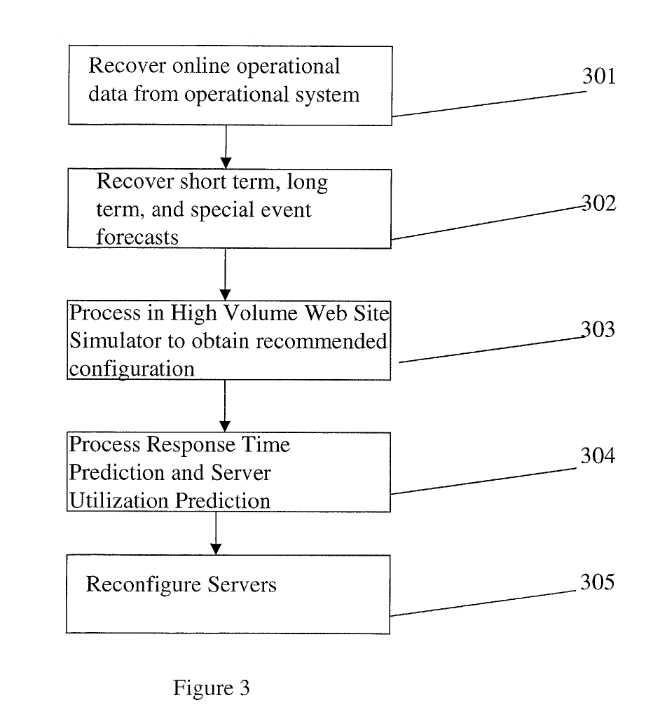

FIG. 3 is one representation of a flow chart for carrying out the method of the invention, on a system of the invention, using a program product of the invention. As shown in the FIGURE, online operational data is recovered from the operational system, 301, along with short term, long term, and special event forecasts, 302, e.g., from an associated database. These are processed in a High Volume Web Site Simulator to obtain recommended system configurations, 303. The recommended system configurations are then used to obtain response time predictions and server utilization predictions, 304, to reconfigure the servers, 305.

To be noted is that FIGS. 2 and 3 show the High Volume Web Site Simulator (FIG. 2, element 107) and processing the various data elements in the High Volume Web Site Simulator to obtain recommended configurations (FIG. 3, element 303). The inputs are operational data and predictions based on historical data. The outputs of the High Volume Web Site Simulator are response time predictions and server utilization predictions (FIG. 2, element 109; FIG. 3, element 304), which are compared to metrics to suggest and/or implement reconfiguration of the servers (FIG. 2, element 110; FIG. 3, element 305).

The suggestion and implementation of a reconfiguration strategy may be based on various goals and metrics. Generally, various methods are available to integrate the demand and performance data for load balancing. These methods include analytic modeling and business model tools.

Modeling, as described above, allows a user to specify one or more objectives, metrics, or measurements from a predefined set, and have the model find the solution that simultaneously meets all requirements, or informs the user that all requirements cannot be simultaneously met.

In one embodiment of the invention, the High Volume Web Site Simulator utilizes an analytic model of a server system based on standard mean value analysis queuing equations, that is, based on queuing models. The user is allowed to specify one or more of the following objectives:

1) Find the mean or peak response time for a specified user arrival rate.

2) Find the maximum user arrival rate such that the mean or peak response time does not exceed a specified value.

3) Find the user arrival rate and response time corresponding to a given number of concurrent users.

4) Find the maximum user arrival rate such that the utilization of a given resource does not exceed a specified value

Starting with a very low user arrival rate, the model iteratively projects the response times, number of concurrent users, and utilizations for increasingly greater user arrival rates. Results from the previous iteration are used to improve the efficiency of projecting the results for the next iteration. The process continues until one or more of the objectives is exceeded, at which time the results for the previous iteration are displayed as the result which meets all objectives.

Alternatively, the user can use a simulation-based modeling tool to project performance without detailed workload parameters being provided by the user. One technique uses business patterns and scenarios for typical e-commerce server installations to define the relevant workload characteristics. This information is used by an integrated analytic simulation model to produce performance estimates for an e-commerce server computer system. These performance estimates can be used for load balancing and for capacity planning.

The business patterns describe the type of work that a computer installation will be used for, such as on-line shopping, on-line trading, etc. and the like. The scenarios describe typical operations within a business pattern, such as browsing a catalog, buying an item, get a stock quote, making a payment or transferring funds, and the like. Both the collection of business patterns and the scenarios are chosen based on historic data, that is, detailed studies of actual customer operations.

The user of the model can define a workload by specifying a business pattern and the relative frequencies of scenarios within that pattern for some current or future e-commerce server. The model will then construct the workload description needed for the performance estimates based on previous data collected from actual measurements of various scenarios on various hardware/software combinations. Abstracted data from previous measurements may be kept in tables within the integrated tool.

While the invention has been described with respect to an e-commerce site, it is, of course, to be understood that the method, system, and program product of the invention may be extended to any queue-server situation, even ones as mundane as “customers and bank tellers” or “barbers and patrons.” As used herein, a “queuing server” is a generalized artifact of the type generally referred to as a server in classical systems analysis-operations research, such as a barber, a bank teller, or a web server, an e-commerce server, an application server, or a data base server.

While the invention has been described with respect to certain preferred embodiments and exemplifications, it is not intended to limit the scope of the invention thereby, but solely by the claims appended hereto.

We claim:

1. A method of configuring a queuing server in queue-queuing server environment comprising:
a. recovering operational data from the queuing server;
b. retrieving activity forecasts;
c. processing the forecasts and operational data to obtain recommended queuing server configurations;
d. processing the recommended queuing server configurations to obtain queuing server response time predictions and server utilization predictions; and
e. reconfiguring the queuing server in response thereto.

2. The method of claim 1 comprising recovering real time operational data from the queuing server.

3. The method of claim 2 comprising retrieving historical activity forecasts.

4. The method of claim 3 comprising processing the historical activity forecasts and real time operational data to obtain recommended server configurations.

5. The method of claim 4 comprising processing the historical activity forecasts and real time operational data using queuing equations to obtain recommended server configurations.

6. The method of claim 5 comprising specifying one or more of the following objectives to drive a solution set to the queuing equations:
1) response time for a specified user arrival rate;
2) user arrival rate such that the response time does not exceed a specified value;
3) user arrival rate and response time corresponding to a given number of concurrent users; or
4) maximum user arrival rate such that the utilization of a given resource does not exceed a specified value.

7. The method of claim 4 comprising processing the historical activity forecasts and real time operational data using simulation based modeling to obtain recommended server configurations.

8. The method of claim 1 wherein the queuing server is an e-commerce server.

9. A method of configuring a server in an e-commerce environment comprising:
a. recovering operational data from the server;
b. retrieving activity forecasts;
c. processing the forecasts and operational data to obtain recommended server configurations;
d. processing the recommended server configurations to obtain server response time predictions and server utilization predictions; and
e. reconfiguring the server in response thereto

10. The method of claim 9 comprising recovering real time operational data from the server.

11. The method of claim 10 comprising retrieving historical activity forecasts

12. The method of claim 11 comprising processing the historical activity forecasts and real time operational data to obtain recommended server configurations.

13. The method of claim 12 comprising processing the historical activity forecasts and real time operational data using queuing equations to obtain recommended server configurations.

14. The method of claim 13 comprising specifying one or more of the following objectives to drive a solution set to the queuing equations:
1) response time for a specified user arrival rate;
2) user arrival rate such that the response time does not exceed a specified value;
3) user arrival rate and response time corresponding to a given number of concurrent users; or
4) maximum user arrival rate such that the utilization of a given resource does not exceed a specified value.

15. The method of claim 12 comprising processing the historical activity forecasts and real time operational data using simulation based modeling to obtain recommended server configurations.

16. A system comprising a web server and a scalable application server, said system adapted to interface with at least one client, said system being controlled and configured to carry out the process of
a. recovering operational data from the server;
b. retrieving activity forecasts;
c. processing the forecasts and operational data to obtain recommended server configurations;
d. processing the recommended server configurations to obtain server response time predictions and server utilization predictions; and
e. reconfiguring the server in response thereto.

17. The system of claim 16 where the method further comprises recovering real time operational data from the server.

18. The system of claim 17 where the method further comprises retrieving historical activity forecasts.

19. The system of claim 18 where the method further comprises processing the historical activity forecasts and real time operational data to obtain recommended server configurations.

20. The system of claim 19 where the method further comprises processing the historical activity forecasts and real time operational data using queuing equations to obtain recommended server configurations.

21. The system of claim 20 where the method further comprises specifying one or more of the following objectives to drive a solution set to the queuing equations:
1) response time for a specified user arrival rate;
2) user arrival rate such that the response time does not exceed a specified value;
3) user arrival rate and response time corresponding to a given number of concurrent users; or
4) maximum user arrival rate such that the utilization of a given resource does not exceed a specified value.

22. The system of claim 19 where the method further comprises processing the historical activity forecasts and real time operational data using simulation based modeling to obtain recommended server configurations.

23. A program product comprising computer readable program code on one or more media, said program code being capable of controlling and configuring a computer system having one or more computers to perform the process of
a. recovering operational data from the server;
b. retrieving activity forecasts;
c. processing the forecasts and operational data to obtain recommended server configurations;
d. processing the recommended server configurations to obtain server response time predictions and server utilization predictions; and
e. reconfiguring the server in response thereto.

24. The program product of claim 23 where the process comprises recovering real time operational data from the server.

25. The program product of claim 24 where the process comprises retrieving historical activity forecasts.

26. The program product of claim 25 where the process comprises processing the historical activity forecasts and real time operational data to obtain recommended server configurations.

27. The program product of claim 26 where the process comprises processing the historical activity forecasts and real time operational data using queuing equations to obtain recommended server configurations.

28. The program product of claim 27 where the process comprises specifying one or more of the following objectives to drive a solution set to the queuing equations:
1) response time for a specified user arrival rate;
2) user arrival rate such that the response time does not exceed a specified value;
3) user arrival rate and response time corresponding to a given number of concurrent users; or
4) maximum user arrival rate such that the utilization of a given resource does not exceed a specified value.

29. The program product of claim 26 where the process comprises processing the historical activity forecasts and real time operational data using simulation based modeling to obtain recommended server configurations.
